(19) United States
(12) Patent Application Publication
(10) Pub. No.: US 2002/0141200 A1
(43) Pub. Date: Oct. 3, 2002

(54) Light conductive optic fiber pompon

(76) Inventor: Tang-Mo Pan, Taipei (TW)

Correspondence Address: Tang-Mo Pan, P.O. Box No.6-57, Chung-Ho City, Taipei Hsien, 235, TW

(21) Appl. No.: 09/818,518

(22) Filed: Mar. 28, 2001

(51) Int. Cl. G09F 13/00; F21V 7/04

(52) U.S. Cl. 362/551

(57) ABSTRACT

The light conductive optic fiber pompon of the invention consists of a plurality of acrylic filaments, blended with optic fibers, or added with the gold threads. After heat treatment, it becomes a semi-circular and round ball type pompon. A bowl is attached to the bottom of the pompon with hidden luminary (such as LED). When the luminary emits the light being therefore transferred to the tip of the optic fiber to produce twinkles. The light color of pompon varies with the color of the luminary to make the pompon a fancy, beautiful luminescent ornament.

### BACKGROUND OF THE INVENTION

The prior technology of optic fiber luminary has been generally employ to ornament clocks and artificial flowers as shown in FIG. 18. Where the petal 91 of plastic flowers surrounds numerous optic fibers 92 situated in the center with a protective tube 93 and a band 94 to tie the optic fiber 92 and the protective tube 93 together. While the lower ends of the optic fibers (not shown in the figure) are under direct lighting, the light ray will radiate to the upper ends of the optic fiber to produce a luminance, creating a novel and good-looking vision. However, the combination of artificial flower with the optic fiber not only clearly exposes every filament of the optic fiber, but also renders a falsehood. Too much of artificial work and too much exposure of optic fiber often lead to an easy recognition at the first glance that it is an optic fiber flower. The key object of the invention is to seek how to hide the luminance created by the optic fiber in the depth of flower in an attempt to make it a best effective ornament.

### SUMMARY OF THE INVENTION

A light conductive optic fiber pompon comprises a bundle of acrylic filament blended with numerous optic fibers, or a plurality of acrylic filaments mixed with numerous optic fibers, or a bundle of nylon filaments containing the gold threads. The bundle is bound into several sections with band lines at equidistance, and each section is cut off with a band line remaining on it. The length of filament at one end of band line is longer than that at the other end. The short bundle is put in an oven for heating. The acrylic filament when being heated, will become disheveled, and the nylon yarn, after heated, will contact to leave the extended gold threads. Eventually the bundle of the filament is alternated into a pompon with the many optic fibers or gold threads left inside. The bottom of the pompon is attached with a bowl to form a complete flower. The bowl is provided with a luminary. When the luminary begins to light, the light will transfer from the bottom to the top of optic fibers or the gold threads and the light spots appear on the surface of the pompon. The color of light spots vary with the color of the luminary which is made a beautiful luminescent ornament

### BRIEF DESCRIPTION OF THE DRAWINGS

FIG. 1 shows the first step for making the light conductive optic fiber pompon of the invention.

FIG. 2 shows the second step for making the light conductive optic fiber pompon of the invention.

FIG. 3 shows the third step for making the light conductive optic fiber pompon of the invention.

FIG. 4 shows the fourth step for making the light conductive optic fiber pompon of the invention.

FIG. 5 shows a stereo piece of light conductive flower.

FIG. 6 shows a cross section of light conductive flower.

FIG. 7 shows the first step for making another embodiment of the light conductive optic fiber pompon of the invention.

FIG. 8 shows the second step for making another embodiment of the light conductive optic fiber pompon of the invention.

FIG. 9 shows the third step for making another embodiment of the light conductive optic fiber pompon of the invention.

FIG. 10 shows the fourth step for making another embodiment of the light conductive optic fiber pompon of the invention.

FIG. 11 shows another embodiment of a stereo piece of light conductive flower.

FIG. 12 shows another embodiment of a cross section of light conductive flower.

FIG. 13 is the schematic diagram showing the assembly of the light conductive optic fiber pompon and luminescent bowl.

FIG. 14 is the schematic diagram showing another embodiment assembly of the light conductive optic fiber pompon and luminescent bowl.

FIG. 15 shows the circuit of controller for two light conductive optic fiber pompon and flower.

FIG. 16 shows that the light conductive optic fiber pompon used as eyes for the toy dog.

FIG. 17 shows the light conductive optic fiber flower is planted in the flower pot.

FIG. 18 is cross section of prior art of luminescent artificial flower.

### DETAILED DESCRIPTION OF THE INVENTION

The invention is explained in detail with the aid of embodiment illustrated in the attached drawings.

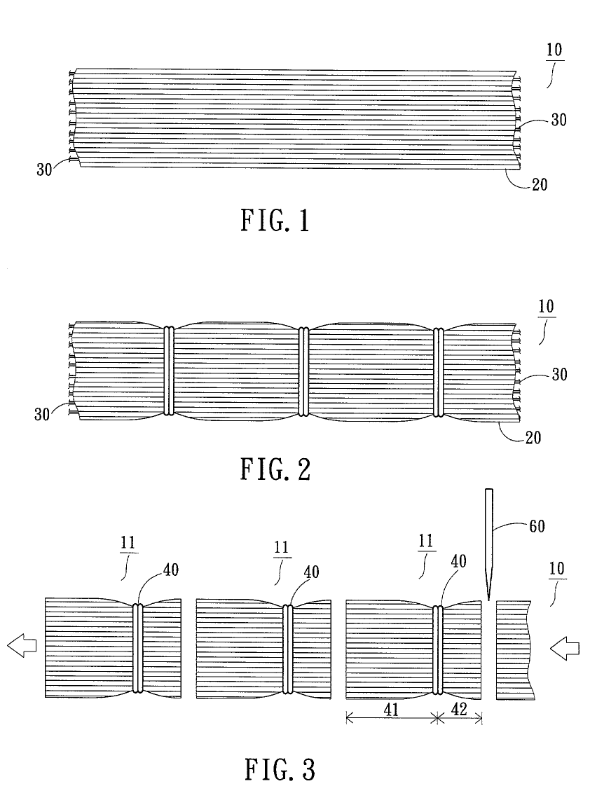

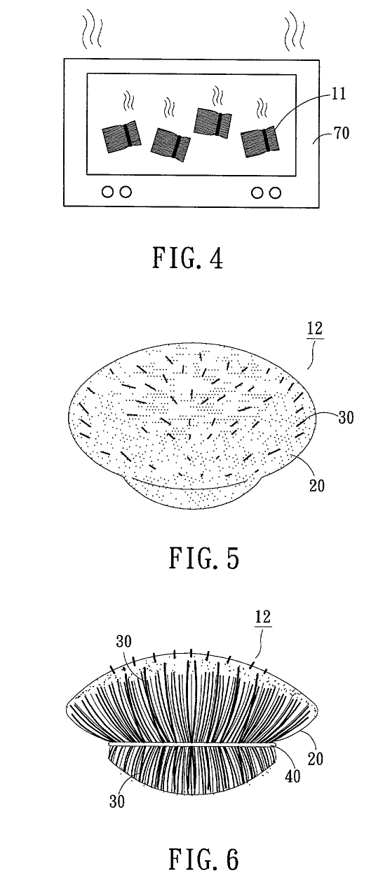

FIGS. 1 through 4 show the step for making the light conductive optic fiber pompons, FIG. 1 shows numerous filaments in particular the acrylic filaments 20 (they can be wooly nylon or polyester filaments.) Mix the acrylic filament with numerous optic fibers 30 (preferably the optic fiber be close to at the center) and bind them into a bundle 10 with equidistant band lines 40 as shown in FIG. 2. Use a cutting wheel 60 to cut the bundle into short sections 11 where the length of filament 41 shall be longer than the filament 42 as shown in FIG. 4. Finally place the short section 11 into an oven 70 to be heated at 50° C. After heated, a physical change takes place in the acrylic filament 20 which becomes disheveled, the longer end 41 becomes a semi-circular pompon 12, its stereo figure is illustrated in FIG. 5 and the cross section in FIG. 6.

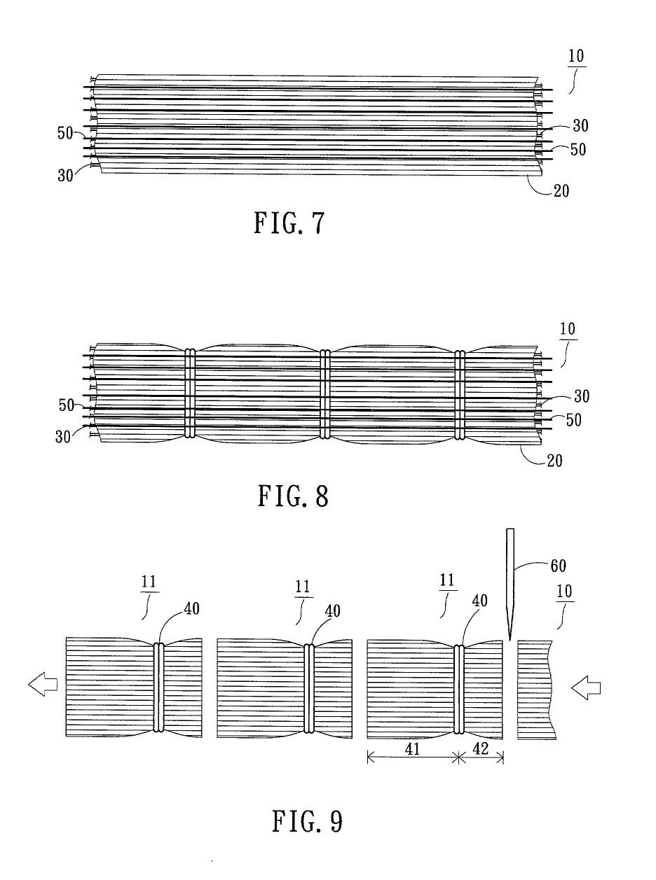

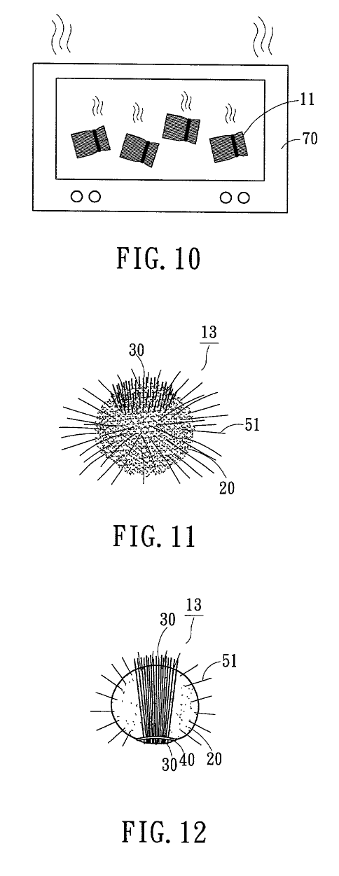

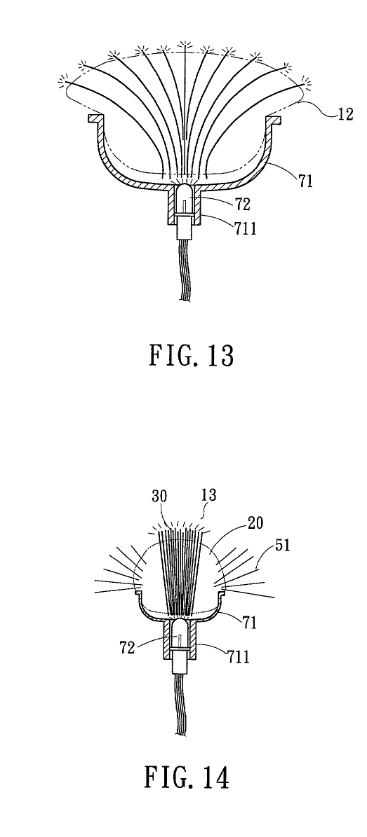

FIGS. 7 through 8 show the steps for making another embodiment of the light conductive optic fiber pompon that are in reality identical to that making the aforesaid light conductive optic fiber pompon. One difference is that the nylon filaments 50 containing the gold threads 51 are added in addition to the acrylic filaments 20 (as shown in FIGS. 12 and 13.) After heated, the nylon filaments 50 contract, and the gold threads 51 remain straight. While the short section 11 is heated, the acrylic filaments 20 become disheveled, the nylon filament contracts, the gold threads 51 expose and the optic fibers 30 mingle in the disheveled acrylic filament 20, forming a ball-shaped pompon 13 as illustrated in FIG. 12. Where the gold threads 51 stand up hedgehog-like and the optic fibers 30 flock in the center looked like a flower bud. From its appearance, it is looked as pompon flower. Since the acrylic fiber 20 and the gold threads present varying color, it looks as really a fresh colorful flower. FIGS. 13 and 14 show an embodiment of the pompon of the invention. The pompon is attached a bowl 71 to form a piece of flower. Beneath the bowl 71, there provides a bundle ring 711 containing a luminary 72 (such as LED, small Christmas bulb, luminescent chip). While the luminary 72 is powered to emit the light, the light will be transferred from the lower end to the upper end of the optic fibers 30, many light spots twinkle on the tip of optic fiber 30, producing an attractive and fancy effect. In addition, the light color of the optic fibers varies with the color light the luminary 72 produces. If the luminary produces the red light, the optic fibers flicker in red, if yellow light, the optic fiber flicker in yellow, if green light, the optic fibers flicker in green. The color diversity depends on what color the luminary 72 produces.

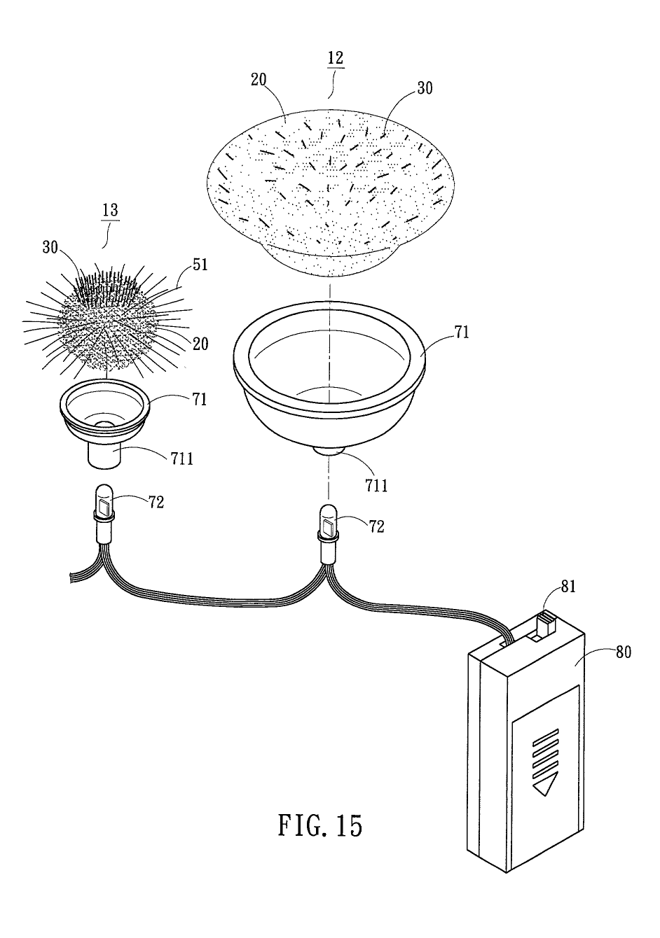

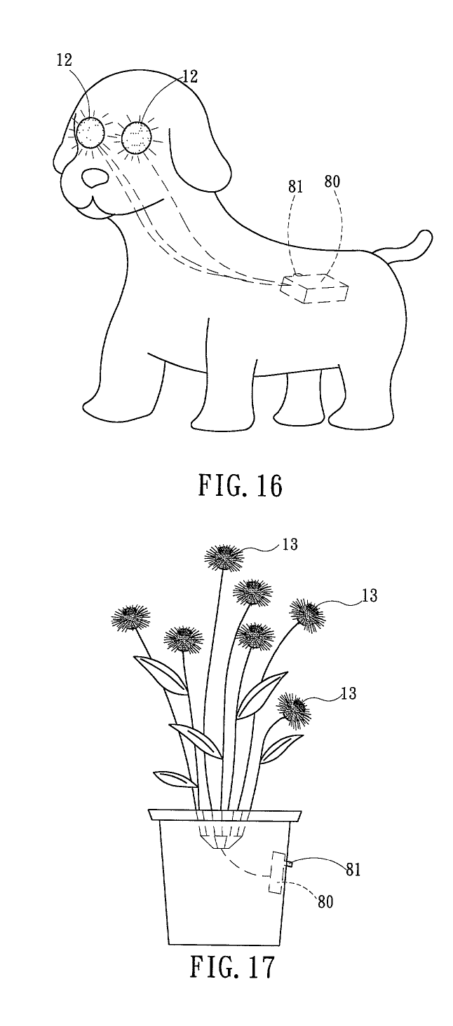

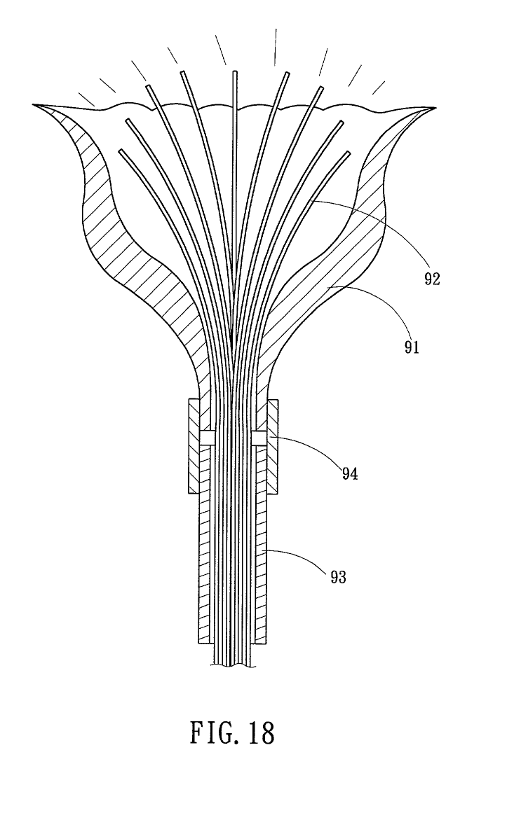

As shown in FIG. 15, the luminary 72 is linked the power controller 80 and a shift switch 81. While the switch is on, the optic fibers in pompon flowers 12 and 13 will flicker. While the switch is off, the light in the optic fibers goes off too. As shown in FIG. 17, the optic fiber pompon flower 13 is planted in a flower pot and controlled by the controller 80 to excite the optic fiber or not.

The optic fiber pompon has a broad application, such as used on the luminescent hat, brooch, and rings. The invention realizes the following achievements:

1. The semi-circular or round ball pompons are looked like a plat flower, vivid and fresh. When a luminary is provided, the light will be transferred to the tip of the optic fibers to produce twinkles, an outstanding beauty effect.

2. The pompon shape offers great diversity of harmonious application with flower pot, brooch, earring, hat, Christmas decoration and animal toy.

3. The light color of the pompon varies with that of the luminary. When a multi-color pompon is displayed, it offer a fancy and good-feeling vision.

1. A light conductive optic fiber pompon comprises a plurality of filaments, numerous optic fibers, a band line binding the filaments and optic fibers together firmly, a lighting device capable of lighting and conducting light to the optic fibers, with the assembly of these components, the filaments become disheveled, and the optic fibers hiding in the filament become the light conductor, when a luminary is linked at the lower end of optic fibers and begins to emit the light, the light will be transferred to the tip of the optic fibers that produce twinkles.

2. The light conductive optic fiber pompon of claim 1, wherein the pompon is blended with many gold threads which stand up hedgehog-like on the surface of the pompon.

3. The light conductive optic fiber pompon of claim 1, wherein the gold threads are blended in the nylon filaments. After heated, the nylon filaments contract and the gold threads stay on the top of the pompon.

4. The light conductive optic fiber pompon of claim 1, wherein the said filaments are acrylic filaments.

5. The light conductive optic fiber pompon of claim 1, wherein after bound and cut, the filaments at one end is longer than that at other end for the short section.

6. The light conductive optic fiber pompon of claim 1 or 2, wherein the luminary device constitutes a bowl and a hidden luminary.
